(19) United States
(12) Patent Application Publication
(10) Pub. No.: US 2025/0104414 A1
(43) Pub. Date: Mar. 27, 2025

(54) Conversational Assistants For Emergency Responders

(71) Applicant: Google LLC, Mountain View, CA (US)

(72) Inventors: Kolati Mallikarjuna Rao, San Diego, CA (US); Bhavikkumar R. Patel, San Diego, CA (US)

(73) Assignee: Google LLC, Mountain View, CA (US)

(21) Appl. No.: 18/471,937

(22) Filed: Sep. 21, 2023

(51) Int. Cl. G06V 10/96; G06V 20/40; G06V 40/10; G08B 25/14; H04L 51/02

(52) U.S. Cl. CPC G06V 10/96; G06V 20/41; G06V 40/10; H04L 51/02; G08B 25/14

(57) ABSTRACT

A method includes capturing data representing an emergency scene, the data including at least one of image data, sound data, or video data representing the emergency scene. The method also includes generating, using a generative model, based on the data representing the emergency scene, a descriptive summary of the emergency scene. The method further includes providing the descriptive summary of the emergency scene to an emergency responder.

### TECHNICAL FIELD

This disclosure relates to conversational assistants for emergency responders.

### BACKGROUND

Increasingly, users are using conversational assistants to interact with user devices. A conversational assistant provides a user interface that is configured to mimic interactions with a live person.

### SUMMARY

One aspect of the disclosure provides a computer-implemented method for providing a conversational assistant for emergency responders. The computer-implemented method, when executed on data processing hardware, causes the data processing hardware to perform operations including capturing data representing an emergency scene, the data including at least one of image data, sound data, or video data representing the emergency scene; generating, using a generative model, based on the data representing the emergency scene, a descriptive summary of the emergency scene; and providing the descriptive summary of the emergency scene to an emergency responder.

Implementations of the disclosure may include one or more of the following optional features. In some implementations, the generative model includes a classifier model configured to, based on the data representing the emergency scene, identify aspects of the emergency scene, and a natural language processing model configured to, based on the aspects of the emergency scene, generate the descriptive summary of the emergency scene. In some examples, the operations also include providing, using a conversational assistant, the descriptive summary of the emergency scene to the emergency responder.

In some examples, the operations also include detecting an emergency and automatically, in response to detecting the emergency: capturing the data representing the emergency scene, generating the descriptive summary of the emergency, and providing the descriptive summary to the emergency responder. Detecting the emergency may include receiving, from a person, an indication of the emergency. Detecting the emergency may include receiving, from a vehicle involved in the emergency, an indication of the emergency.

In some implementations, the descriptive summary includes at least some of the data representing the emergency scene. The descriptive summary may be generated to assist the emergency responder in preparing for the emergency scene upon arrival. The descriptive summary may include one or more of states of one or more vehicles involved in an accident at the emergency scene; states of one or more airbags; locations of one or more vehicles at the emergency scene; a health status of one or more persons involved in the accident at the emergency scene; locations of one or more persons involved in the accident; a presence of fire; a presence of water; a presence of a roadway; damage to a roadway; a terrain topology; a presence of a leaking fluid; debris on a roadway; a roadblock condition; sounds at the emergency scene including speaking, crying, moaning, or barking; a description of surroundings; or a presence of weapons. In some examples, the descriptive summary includes text and the operations also providing the text to a text-to-speech (TTS) system, the TTS system configured to convert the text into TTS audio data that conveys the descriptive summary as synthetic speech, providing the descriptive summary of the emergency scene to the emergency responder includes providing the TTS audio data to the emergency responder.

In some implementation, capturing the data representing the emergency scene includes capturing data using at least one of a camera or a microphone in communication with a user device associated with a person who is present at the emergency scene. Here, the descriptive summary may include an image of the person to facilitate identification of the person by the emergency responder. Additionally or alternatively, capturing the data representing the emergency scene includes capturing data using at least one of a camera or a microphone of a vehicle involved in the emergency scene. Additionally or alternatively, capturing the data representing the emergency scene includes capturing sensor data from one or more sensors in communication with the data processing hardware, the one or more sensors including at least one of a speed sensor, an altitude sensor, an accelerometer, a braking sensor, a position sensor, a temperature sensor, or a light sensor.

Another aspect of the disclosure provides a system including data processing hardware, and memory hardware in communication with the data processing hardware and storing instructions that, when executed on the data processing hardware, causes the data processing hardware to perform operations. The operations including capturing data representing an emergency scene, the data including at least one of image data, sound data, or video data representing the emergency scene; generating, using a generative model, based on the data representing the emergency scene, a descriptive summary of the emergency scene; and providing the descriptive summary of the emergency scene to an emergency responder.

Implementations of the disclosure may include one or more of the following optional features. In some implementations, the generative model includes a classifier model configured to, based on the data representing the emergency scene, identify aspects of the emergency scene, and a natural language processing model configured to, based on the aspects of the emergency scene, generate the descriptive summary of the emergency scene. In some examples, the operations also include providing, using a conversational assistant, the descriptive summary of the emergency scene to the emergency responder.

In some examples, the operations also include detecting an emergency and automatically, in response to detecting the emergency: capturing the data representing the emergency scene, generating the descriptive summary of the emergency, and providing the descriptive summary to the emergency responder. Detecting the emergency may include receiving, from a person, an indication of the emergency. Detecting the emergency may include receiving, from a vehicle involved in the emergency, an indication of the emergency.

In some implementations, the descriptive summary includes at least some of the data representing the emergency scene. The descriptive summary may be generated to assist the emergency responder in preparing for the emergency scene upon arrival. The descriptive summary may include one or more of states of one or more vehicles involved in an accident at the emergency scene; states of one or more airbags; locations of one or more vehicles at the emergency scene; a health status of one or more persons involved in the accident at the emergency scene; locations of one or more persons involved in the accident; a presence of fire; a presence of water; a presence of a roadway; damage to a roadway; a terrain topology; a presence of a leaking fluid; debris on a roadway; a roadblock condition; sounds at the emergency scene including speaking, crying, moaning, or barking; a description of surroundings; or a presence of weapons. In some examples, the descriptive summary includes text and the operations also providing the text to a text-to-speech (TTS) system, the TTS system configured to convert the text into TTS audio data that conveys the descriptive summary as synthetic speech, providing the descriptive summary of the emergency scene to the emergency responder includes providing the TTS audio data to the emergency responder.

In some implementation, capturing the data representing the emergency scene includes capturing data using at least one of a camera or a microphone in communication with a user device associated with a person who is present at the emergency scene. Here, the descriptive summary may include an image of the person to facilitate identification of the person by the emergency responder. Additionally or alternatively, capturing the data representing the emergency scene includes capturing data using at least one of a camera or a microphone of a vehicle involved in the emergency scene. Additionally or alternatively, capturing the data representing the emergency scene includes capturing sensor data from one or more sensors in communication with the data processing hardware, the one or more sensors including at least one of a speed sensor, an altitude sensor, an accelerometer, a braking sensor, a position sensor, a temperature sensor, or a light sensor.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a generative model for providing a descriptive summary of an emergency scene.

FIG. 2 is a schematic view of an example generative model for generating a descriptive summary of an emergency scene.

FIGS. 3A and 3B are example descriptive summaries of example emergency scenes.

FIG. 4 is a flowchart of an example arrangement of operations for a computer-implemented method of providing a descriptive summary of an emergency scene.

FIG. 5 is a flowchart of example arrangement of operations for another computer-implemented method of providing a descriptive summary of an emergency scene.

FIG. 6 is a flowchart of an example arrangement of operations for a computer-implemented method of training a generative model for generating a descriptive summary of an emergency scene.

FIG. 7 is a schematic view of an example computing device that may be used to implement the systems and methods described herein.

Like reference symbols in the various drawings indicate like elements.

### DETAILED DESCRIPTION

Increasingly, users are using conversational assistants to interact with user devices. A conversational assistant provides a user interface that is configured to mimic interactions with a live person. However, conventional conversational assistants do not process or comprehend sounds or visual content of an environment surrounding a user that is interacting with a conversational assistant. To the extent a conventional conversational assistant does process sounds or visual content of an environment surrounding a user, the conversational assistant only does so to isolate utterances of the user from sounds in the environment and/or to identify the user. However, sounds or visual content of an environment may represent information that may be valuable to a conversational interaction with a conversational assistant. For example, an emergency responder interacting with a conversational assistant regarding an emergency scene may benefit greatly from information related to sounds or visual content of an environment that includes the emergency scene.

Implementations herein are directed toward methods and systems capable of providing conversational assistants the ability to process and understand captured sounds or visual content representing a surrounding environment. In particular, implementations herein are directed toward using conversational assistants as an interface between a person present at an emergency scene and an emergency responder that can, based on sounds and/or visual content representing the emergency scene, generate and provide a descriptive summary of the emergency scene to the emergency responder. Notably, the descriptive summary of the emergency scene is generated to provide detailed information that may assist the emergency responder in preparing for the emergency scene upon arrival. For example, such detailed information may expedite the ability provide necessary help more efficaciously, reduce risks of injury or death, save lives, improve public safety, reduce property damage, reduce inconvenience to others, and/or to respond with sufficient personnel and/or equipment.

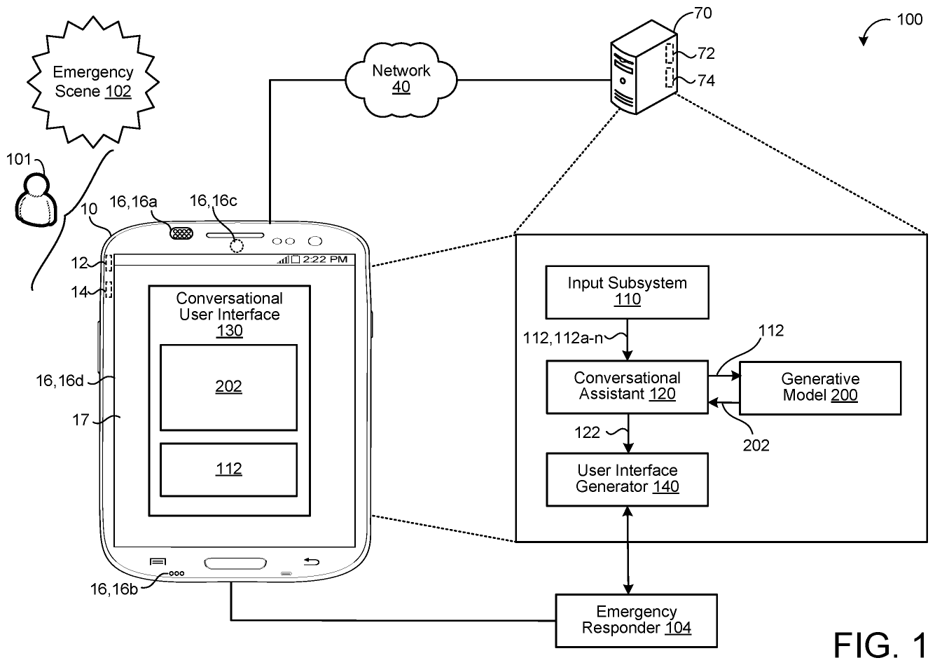

FIG. 1 is a schematic view of an example of a system 100 using a generative model 200 for generating a descriptive summary 202 of an emergency scene 102. In particular, a conversational assistant 120 executing on a remote computing system 70 and/or on a user device 10 associated with a user 101 present at the emergency scene 102 may initiate an emergency communication with an emergency responder 104. The conversational assistant 120 may provide a conversational user interface 130 for execution on the user device 10 for facilitating communications related to the emergency communication between the user 101 and the emergency responder 104. The conversational assistant 120 provides the descriptive summary 202 of the emergency scene 102 to the emergency responder 104. The generative model 200 may execute on the user device 10 or the remote computing system 70 in communication with the user device 10 via a network 40. In some examples, the generative model 200 and the conversational assistant 120 execute together on the user device 10 or the remote computing system 70. Optionally, the conversational assistant 120 may execute on a device/system different than a device/system where the generative model 200 executes, but may access the generative model 200 in the presence of an emergency by providing data 112 captured at the emergency scene 102 to the generative model 200 for processing to generate the descriptive summary 202 of the emergency scene 102. In some implementations, the generative models 200 includes a deep learning model such as a transformer model, a bidirectional autoregressive transformer (BART) model, or a text-to-text transfer transformer (T5) model. As used herein, the conversational assistant may communicate the descriptive summary 202 to one or more emergency devices each associated with an emergency responder 104. The emergency scene 102 may include any number and/or type(s) of emergencies, incidents, events, etc. including, but not limited to, health or medical emergencies, accidents, natural disasters, and criminal behaviors. The emergency responder 104 may be any type of emergency responder including, but not limited to, call center personnel, hotline personnel, police personnel, firefighting personnel, emergency medical technician (EMT) personnel, nurses, and doctors.

The user 101 may correspond to a live person present at the emergency scene 102. For instance, the user 101 may be an individual involved in the emergency scene and potentially injured as result of the emergency. Here, the user 101 may manually invoke the conversational assistant 120 through the user device 10 to initiate the emergency communication with the emergency responder 104 by speaking a trigger/command phrase, providing a user input indication indicating selection of a graphical element for initiating emergency communications, or by any other means. In some situations, the conversational assistant 120 initiates the emergency communication with the emergency responder 104 without any input from the user 101 on the user's 101 behalf. For instance, the user device 10 may detect a presence of an emergency (e.g., a vehicle crash where sensors of the user device 10 capture data indicative of the vehicle crash) and invoke the conversational assistant 120 to initiate the emergency communication with the emergency responder 104. The user device 101 located at the emergency scene 102 is configured to capture emergency data 112 (e.g., image data, sound data, or video data) representing the emergency scene 102 and provide, via the conversational assistant 120, the captured data 112 to the generative model 200 for processing thereof to generate the descriptive summary 202 of the emergency scene 102. The conversational assistant 120 may provide the descriptive summary 202 the emergency responder 104. In some implementations, the conversational assistant 120 (or an initial emergency responder 104) performs semantic analysis on the descriptive summary 202 generated by the generative model 200 to identify emergency responders 104 that are most appropriate for responding to the emergency scene 102. For instance, the conversational assistant 120 may provide the descriptive summary 202 to emergency responders 104 that include an EMT if the descriptive summary 202 indicates there are or may be injured people at the emergency scene in need of medical assistance. Likewise, the conversational assistant 120 may provide the descriptive summary to emergency responders 104 that include firefighters if the descriptive summary 202 indicates the presence of a fire at the emergency scene 102.

Some examples of user devices 10 include, but are not limited to, mobile devices (e.g., mobile phones, tablets, laptops, etc.), computers, wearable devices (e.g., a smart watch, smart glasses, smart goggles, an AR headset, a VR headset, etc.), smart appliances, Internet of things (IoT) devices, vehicle infotainment systems, smart displays, smart speakers, etc. The user device 10 includes data processing hardware 12 and memory hardware 14 in communication with the data processing hardware 12 and stores instructions, that when executed by the data processing hardware 12, cause the data processing hardware 12 to perform one or more operations. The user device 10 further includes one or more input/output devices 16, 16a-n, such as an audio capture device 16, 16a (e.g., microphone) for capturing and converting sounds into electrical signals, an audio output device 16, 16b (e.g., a speaker) for communicating an audible audio signal (e.g., as output audio data from the user device 10), a camera 16, 16c for capturing image data (e.g., images or video), and/or a screen 16, 16d for displaying visual content. Of course, any number and/or type(s) of other input/output devices 16 may be used. The input/output devices 16 may reside on or be in communication with the user device 10. For instance, the user device 10 may execute a graphical user interface 17 for display on the screen 16d the presents the conversational user interface 130 provided by the conversational assistant 120 for facilitating the emergency communication between the user 101 and the emergency responder. Here, the conversational user interface 130 may present a textual representation of the descriptive summary 202 provided to the emergency responder 104. Additionally or alternatively, the descriptive summary 202 and/or the conversational user interface 130 may include captured visual content 112 (e.g., one or more images and/or videos) and/or captured audio content 112 (e.g., one or more audio recordings) of the emergency scene 102 provided by the user 101. The conversational interface 130 may present a dialog of communications/interactions between the user 101 and the emergency responder 104 related to the emergency scene 102. The conversational user interface 130 may permit the user 101 to interact with the assistant 120 via speech captured by the microphone 16b and may optionally present a transcription of the captured speech recognized by an automated speech recognition (ASR) system for display on the screen 16d. The conversational assistant 120 may provide audio data characterizing speech/voice inputs spoken by the user 101 to the emergency responder 104 and/or transcriptions of the speech/voice to the emergency responder 104. The emergency responder 104 may be provided a similar conversational user interface 130 on a device associated with the emergency responder 104.

The user device 10 and/or the remote computing system 70 (e.g., one or more remote servers of a distributed system executing in a cloud-computing environment) in communication with the user device 10 via the network 40 executes an input subsystem 110 configured to receive data 112, 112a-n captured by any number and/or type(s) of data capturing devices (not shown for clarify of illustration) that may reside on any combination of the user device 112 or other devices in communication with the conversational assistant 120. Here, the data 112 includes at least one of image data, sound data, or video data 112 representing the emergency scene 102 that is provided to the generative model 200 for generating the descriptive summary 202 of the emergency scene 102. Example data capturing devices include, but are not limited to, stationary or mobile cameras, microphones, sensors, traffic cameras, security cameras, satellites, portable user devices, wearable devices, vehicle cameras, and vehicle infotainment systems. The data capturing devices may be owned, operated, or provided by any number and/or type(s) of entities. Example images 112 of an emergency scene 102 include, but are not limited to, images of a car involved in an accident, an injured or sick person, a deployed airbag, a shattered window, an injured person or animal, a crying or moaning person, or a barking dog, debris on the ground or road, an unconscious person, fire, flooding, or an active shooter. Example videos 112 of an emergency scene 102 include, but are not limited to, videos of a car involved in an accident, an injured or sick person, a deployed airbag, a shattered window, an injured person or animal, a crying or moaning person, or a barking dog, debris on the ground or road, an unconscious person, fire, flooding, or an active shooter. Example audio 112 of an emergency scene 102 includes, but is not limited to, sounds of a car involved in an accident, an injured or sick person, a deployed airbag, a shattered window, an injured person or animal, a crying or moaning person, or a barking dog, debris on the ground or road, an unconscious person, fire, flooding, or an active shooter.

In some examples, an emergency at an emergency scene 102 is automatically detected by processing a stream of monitoring data. Here, detection of the emergency automatically triggers the input subsystem 110 to store the streaming data 112 and/or automatically trigger capture of additional or alternative data 112. Detection of the emergency triggers the conversational assistant 120 to control the generative model 200 to generate a descriptive summary 202 of the emergency scene 102, and to provide the descriptive summary 202 to the appropriate emergency responder(s) 104. The descriptive summary 202 may include a natural language description that summarizes pertinent details of the emergency scene 102 based on the captured data 112 input to the generative model 200. Additionally or alternatively, the descriptive summary 202 may include image data depicting a visual representation of the emergency scene that was captured by the user device 10 or by another image capture device located at the emergency scene 102. As mentioned above, the conversational assistant 120 may perform semantic interpretation (and/or image analysis on visual data) on the descriptive summary to identify the appropriate emergency responder(s) 104 for responding to the emergency scene 102. In some examples, an emergency responder 104 includes an emergency contact associated with the user 101.

Additionally or alternatively, detecting an emergency may include receiving, at the input subsystem 110, an indication of the emergency from a vehicle involved in the emergency. Here, the vehicle may detect the emergency based on sensed data (e.g., activation of an airbag, or a sound of speaking or a scream, moan, cry, bark, glass shattering, debris hitting the ground, or a gunshot,), and a camera or microphone of the vehicle may capture and provide image, sound, or video data 112 to the input subsystem 110. In some examples, the vehicle includes the user device 10 that captures data 112 representing a person's responses to queries regarding the emergency, injuries, persons involved, condition, location, etc. Other devices that may similarly detect and indicate emergencies, and provide data 112 include, but are not limited to, barriers, bridges, motion sensors, water level sensors, and impact sensors.

Additionally or alternatively, detecting an emergency may include receiving an indication of the emergency from a person present at the emergency scene 102 (e.g., the user 101 involved in or a bystander to an emergency). Here, the user 101 may trigger the user device 10 to capture of image, sound, or video data 112 using, for example, the camera 16c or the microphone 16b in communication with the user device 10 associated with the user 101. The user 101 may use the user device 10 to report or indicate the emergency and provide the captured data 112 to the input subsystem 110. In some examples, data 112 captured by the user device 10 includes a picture of the user 101 that is included in the descriptive summary 202 to facilitate identification of the person by an emergency responder 104.

Additionally or alternatively, detecting an emergency may include receiving an indication of the emergency from a safety check system, such as those used to monitor ill or elderly persons. Here, if a person fails to respond to a safety check, the safety check system may trigger capture of image, sound, or video data 112 using, for example, a camera or a microphone in communication with the user device 10 associated with the user 101 that includes the ill or elderly person being monitored, report or indicate the emergency, and provide the captured data 112 to the input subsystem 110.

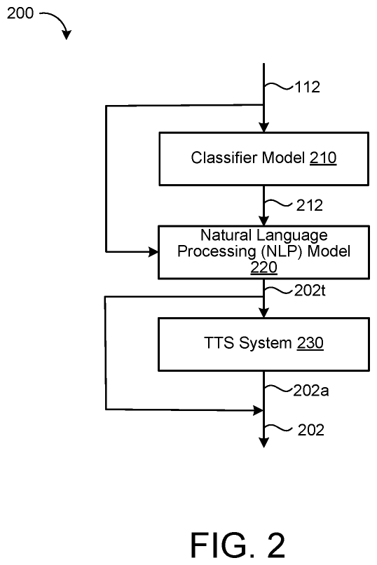

The generative model 200 is configured to processes the data 112 representing the emergency scene 102 to generate the descriptive summary 202 of the emergency scene 106. The descriptive summary 202 of the emergency scene 102 may be provided as text 202, 202t (see FIG. 2) and/or as TTS audio data 202, 202a (see FIG. 2) that conveys the descriptive summary 202 as synthetic speech. The descriptive summary 202 may also include some or all of the data 112. The data 112 may include at least one of image data, sound data, or video data 112 representing the emergency scene 102. Additionally or alternatively, the data 112 may include sensor data from one or more sensors including, but not limited to, a speed sensor, an altitude sensor, an accelerometer, a braking sensor, a position sensor, a temperature sensor, or a light sensor.

A descriptive summary 202 of an emergency scene 102 may include, for example, states of one or more vehicles involved in an accident at the emergency scene; states of one or more airbags; locations of the one or more vehicles at the emergency scene; a health status of one or more persons or animals involved in the accident at the emergency scene; locations of the one or more persons or animals involved in the accident; a presence of fire; a presence of water; a presence of a roadway; damage to a roadway; a terrain topology; a presence of a leaking fluid; debris on a roadway; a roadblock condition; sounds at the emergency scene including speaking, crying, moaning, or barking; a description of surroundings; or a presence of weapons, event timestamps, a type of emergency, a number of people or animals involved, or type of assistance required. The descriptive summary 202 may include a natural language summary of the emergency scene to convey details of the emergency scene 102 that are pertinent for assisting emergency responders 104 for responding to the emergency scene 102 upon arrival.

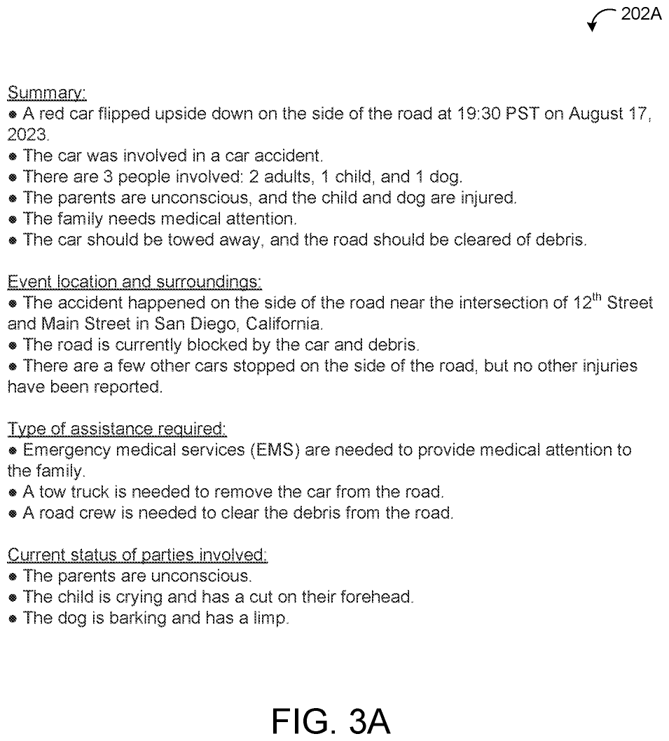

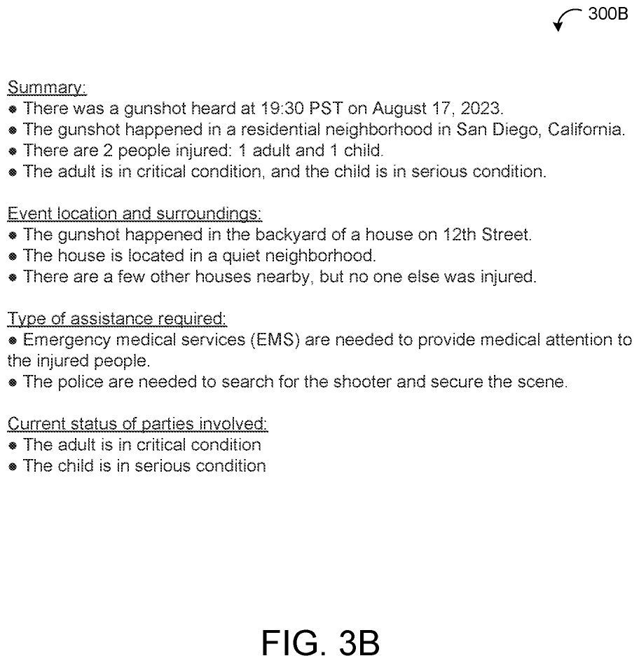

FIG. 3A depicts an example descriptive summary 202A generated by the generative model 200 for a car accident. A computing device associated with the emergency responder 104 may display the descriptive summary 202A and/or audibly output the descriptive summary 202A as synthesized speech. FIG. 3B depicts an example descriptive summary 202B generated by the generative model 200 for a gunshot incident. A computing device associated with the emergency responder 104 may display the descriptive summary 202B and/or audibly output the descriptive summary 202B as synthesized speech.

Returning to FIG. 1, the conversational assistant 120 is configured to provide a conversational user interface 130 that includes conversational, human-like interactions between the emergency responder 104 and the conversational assistant 120 and/or the generative model 200. Here, the conversational assistant 120 may include any number and/or type(s) of models, methods, algorithms, systems, software, hardware, instructions, etc. configured to mimic human-like conversations and/or interactions with the emergency responder 104. The emergency responder's manner of interacting with the user device 10 may be through any number and/or type(s) of inputs. Example inputs include, but are not limited to, text (e.g., entered using a physical or virtual keyboard), spoken utterances, video (e.g., representing gestures or expressions), and clicks (e.g., using a mouse or touch inputs). The conversational assistant 120 is configured to capture and respond to inputs from the emergency responder 104. Notably, the conversational assistant 120 is able to naturally interact with emergency responders 104, and is able to understand and respond to spoken or text-based commands and queries. The conversational assistant 120 may also be able to learn and adapt over time as it interacts with more emergency responders 104 and processes data 112 for more emergencies to improve identifying and responding to emergencies.

The user device 10 and/or the remote computing system 70 also executes a user interface generator 140 configured to provide, for output on an output device of the user device 10 (e.g., on the audio output device(s) 16a or the display 16d), entries/responses 122 of the user 101, conversational assistant 120, and/or the emergency responder 104. Here, the user interface generator 140 displays the entries and the corresponding responses 122 in the conversational user interface 130. In the illustrated example, the conversational user interface 130 is for an interaction between the user 101, or the conversational assistant 120 on the user's behalf, and an emergency responder 104. However, the conversational user interface 130 may also be for a multi-party chat session including interactions amongst multiple emergency responders 104 and the conversational assistant 120.

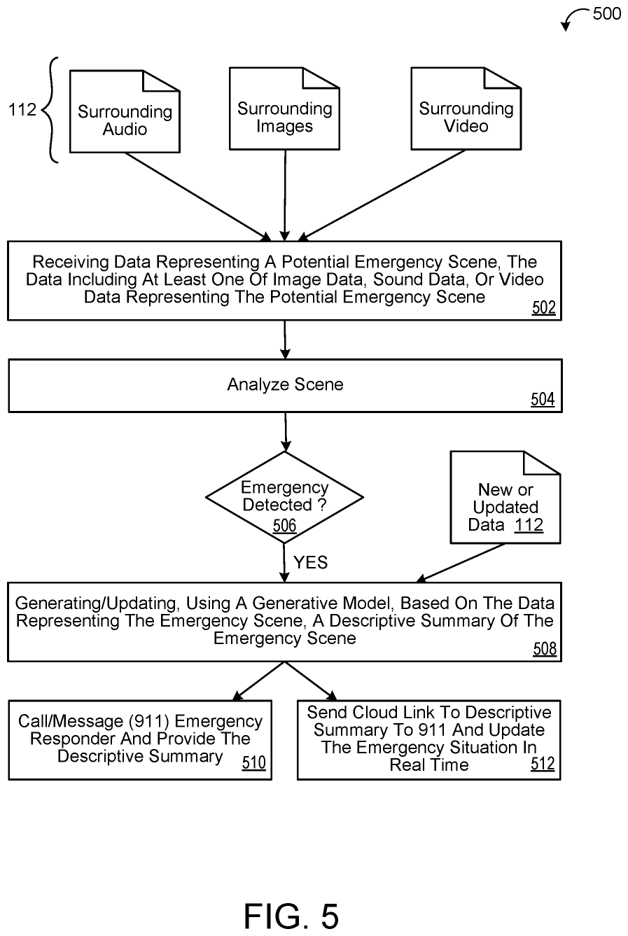

FIG. 2 is a schematic view of an example of a generative model 200. The generative model 200 executes a classifier model 210 configured to process data 112 representing an emergency scene 102 to identify aspects 212 of the emergency scene 102, and a natural language processing (NLP) model 220 configured to, based on the aspects 212 of the emergency scene 102 identified by the classifier model 210, generate the descriptive summary 202 of the emergency scene 102. The NLP model 220 may include a large language model (LLM). Here, the NLP model 220 may, based on the aspects 212 of the emergency scene 102, determine a course of action or response to an emergency. For example, when the classifier model 210 detects aspects 212 of life threatening activities, the NLP model 220 could indicate that the conversational assistant 120 should contact a police office or medical responder. In another example, when the classifier model 210 detects aspects 212 of a vehicle crash, the NPL model 220 could provide information for emergency personnel, such as a location of the incident, a number of people involved, and a summary of the emergency scene 102. As described below in greater detail below with reference to FIG. 5, the classifier model 210 and the NLP model 220 may be trained on a supervised and/or an unsupervised training data set that includes sounds, images, videos, and/or descriptions of emergencies.

In some examples, the descriptive summary 202 includes text 202t provided by the conversational assistant 120 to the emergency responder 104. Additionally or alternatively, the generative model 200 includes a text-to-speech (TTS) system 230 configured to convert the text 202t into TTS audio data 202a that conveys the descriptive summary 202 as synthetic speech, and the conversational assistant 120 provides the TTS audio data 202a to the emergency responder 104. Here, the TTS audio data 202a may include spectrograms, and/or a time sequence of audio waveform data representing the synthetic speech. The descriptive summary 202 may also include the data 112 including at least one of image data, sound data, or video data representing the emergency scene 102.

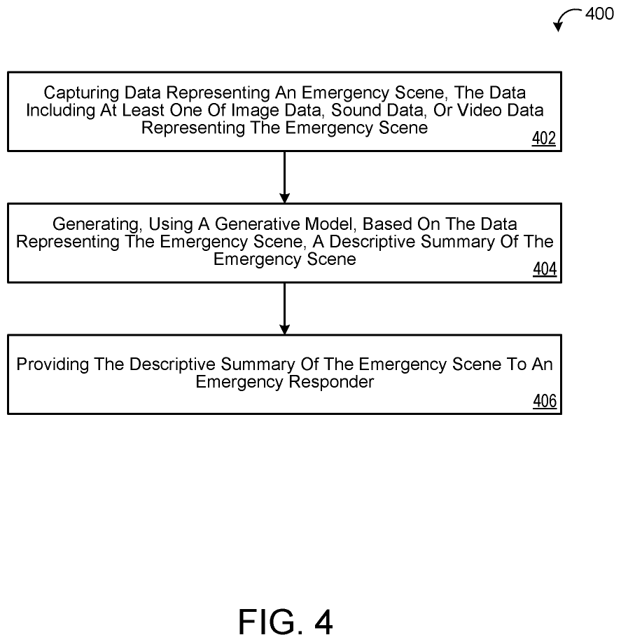

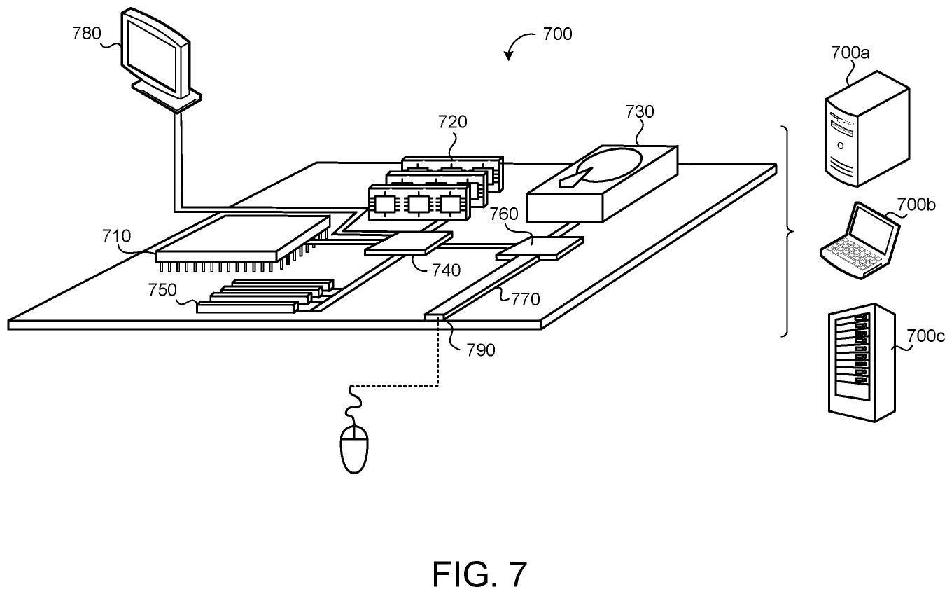

FIG. 4 is a flowchart of an exemplary arrangement of operations for a computer-implemented method 400 of providing a descriptive summary 202 of an emergency scene 102. The operations may be performed by data processing hardware 710 (FIG. 7) (e.g., the data processing hardware 12 of the user device 10 or the data processing hardware 72 of the remote computing system 70) based on executing instructions stored on memory hardware 720 (e.g., the memory hardware 14 of the user device 10 or the memory hardware 74 of the remote computing system 70).

At operation 402, the method 400 includes capturing data 112 representing an emergency scene 102. The data 112 may include image data, sound data, or video data representing the emergency scene 102. At operation 404, the method 400 includes generating, using the generative model 200, based on the data 112 representing the emergency scene 102, a descriptive summary 202 of the emergency scene 102. At operation 406, the method 400 includes the conversational assistant 120 providing the descriptive summary 202 of the emergency scene 102 to an emergency responder 104.

FIG. 5 is a flowchart of an exemplary arrangement of operations for another computer-implemented method 500 of providing a descriptive summary 202 of an emergency scene 102. The operations may be performed by data processing hardware 710 (FIG. 7) (e.g., the data processing hardware 12 of the user device 10 or the data processing hardware 72 of the remote computing system 70) based on executing instructions stored on memory hardware 720 (e.g., the memory hardware 14 of the user device 10 or the memory hardware 74 of the remote computing system 70).

At operation 502, the method 500 includes the conversational assistant 120 receiving captured data 112 representing a potential emergency scene 102. The data 112 may include image data (e.g., of a car crash, an injured or sick person or animal, an unconscious person, fire, a firearm, a flood, etc.), sound data (e.g., of an airbag inflating, a child crying, moaning in pain, a dog barking, a person asking for assistance, etc.), or video data (e.g., of an injured or sick person or animal, an unconscious person, fire, a firearm, a flood, etc.) representing the emergency scene 102.

At operation 504, the method 500 includes the classifier model 210 processing the received data 112 to automatically analyze the scene 102 for an emergency. Additionally or alternatively, the conversational assistant detects, operation 504, an emergency at the scene 102 based on the user 101 reporting the emergency. When a decision is affirmative (“YES”) that the emergency is detected at operation 506, the method 500 includes, at operation 508, the generative model 200 (i.e., the NLP/LLM model 220) processing the data 112 to generate the descriptive summary 202 of the emergency scene 102. At operation 510, the method 500 includes the conversational assistant 120 initiating a 911 call or sending a message to a 911 service for providing the descriptive summary 202 of the emergency scene 102 to an emergency responder 104. Additionally or alternatively, the method 500 may include, at operation 512, the conversational assistant 120 sending a cloud link to a 911 service for retrieving the descriptive summary 202. Here, the generative model 200 may, based on additional or updated data 112 representing the emergency scene 102, generate an updated descriptive summary 202 of the emergency scene 102.

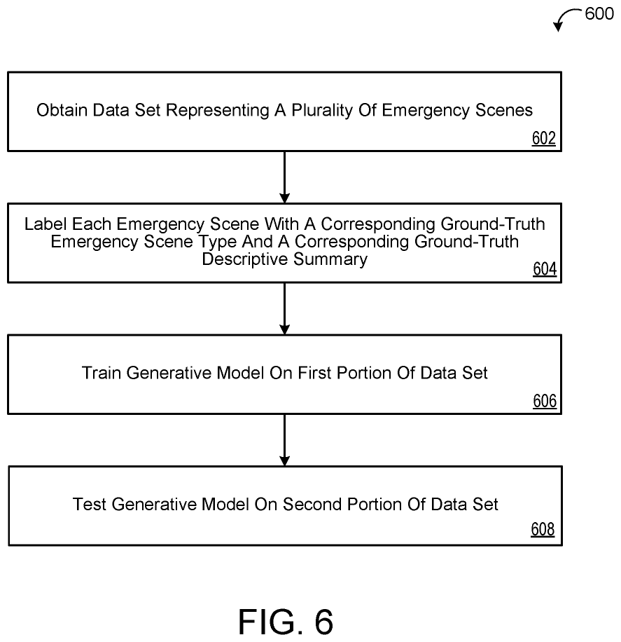

FIG. 6 is a flowchart of an exemplary arrangement of operations for a computer-implemented method 600 of training the generative model 200 for generating a descriptive summary 202 of an emergency scene 102. The operations may be performed by data processing hardware 710 (FIG. 7) (e.g., the data processing hardware 12 of the user device 10 or the data processing hardware 72 of the remote computing system 70) based on executing instructions stored on memory hardware 720 (e.g., the memory hardware 14 of the user device 10 or the memory hardware 74 of the remote computing system 70).

At operation 602, the method 600 includes obtaining a data set representing a plurality of emergency scenes 102. Here, the data set includes, for each particular emergency scene 102, corresponding captured sound, image, and/or video data 112 representing the particular emergency scene 102. Here, the data set may represent a diverse and large set of emergency scenes 102 to ensure the generative model 200 can generalize well to new emergency scenes 102.

At operation 604, the method 600 includes, for each particular emergency scene 102, labeling the particular emergency scene 102 with a corresponding ground-truth emergency scene type and a corresponding ground-truth descriptive summary 202.

At operation 606, the method 600 includes training the generative model 200 using supervised learning on a first training portion of the data set. Here, training the generative model 200 includes inputting the data 112 for each particular emergency scene 102 into the generative model 200 and adjusting coefficients on the generative model 200 until it can accurately predict the corresponding ground-truth emergency scene type and the corresponding ground-truth descriptive summary 202. Notably, the classifier model 210 may be trained to predict the corresponding ground-truth emergency scene type and the NLP/LLM model 220 may be trained to predict the corresponding ground-truth descriptive summary 202. In some examples, the generative model 200 includes a deep learning model trained on the data set to predict both an emergency scene type and a descriptive summary from input data 112 for a particular emergency scene 202. IN these examples, the generative model 200 may include, without limitation, a transformer model, a bidirectional autoregressive transformer (BART) model, or a text-to-text transfer transformer (T5) model. At operation 608, the method 600 may optionally test the generative model on a second test portion of the data set that was withheld from the first training portion (i.e., unseen data).

FIG. 7 is schematic view of an example computing device 700 that may be used to implement the systems and methods described in this document. The computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 700 includes a processor 710 (i.e., data processing hardware) that can be used to implement the data processing hardware 12 and/or 72, memory 720 (i.e., memory hardware) that can be used to implement the memory hardware 14 and/or 74, a storage device 730 (i.e., memory hardware) that can be used to implement the memory hardware 14 and/or 74, a high-speed interface/controller 740 connecting to the memory 720 and high-speed expansion ports 750, and a low speed interface/controller 760 connecting to a low speed bus 770 and a storage device 730. Each of the components 710, 720, 730, 740, 750, and 760, are interconnected using various busses, and may be mounted on a common motherboard or in other manners as appropriate. The processor 710 can process instructions for execution within the computing device 700, including instructions stored in the memory 720 or on the storage device 730 to display graphical information for a graphical user interface (GUI) on an external input/output device, such as display 780 coupled to high speed interface 740. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 720 stores information non-transitorily within the computing device 700. The memory 720 may be a computer-readable medium, a volatile memory unit(s), or non-volatile memory unit(s). The non-transitory memory 720 may be physical devices used to store programs (e.g., sequences of instructions) or data (e.g., program state information) on a temporary or permanent basis for use by the computing device 700. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 730 is capable of providing mass storage for the

computing device 700. In some implementations, the storage device 730 is a computer-readable medium. In various different implementations, the storage device 730 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 720, the storage device 730, or memory on processor 710.

The high speed controller 740 manages bandwidth-intensive operations for the computing device 700, while the low speed controller 760 manages lower bandwidth-intensive operations. Such allocation of duties is exemplary only. In some implementations, the high-speed controller 740 is coupled to the memory 720, the display 780 (e.g., through a graphics processor or accelerator), and to the high-speed expansion ports 750, which may accept various expansion cards (not shown). In some implementations, the low-speed controller 760 is coupled to the storage device 730 and a low-speed expansion port 790. The low-speed expansion port 790, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 700a or multiple times in a group of such servers 700a, as a laptop computer 700b, or as part of a rack server system 700c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed

by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
capturing data representing an emergency scene, the data comprising at least one of image data, sound data, or video data representing the emergency scene;
generating, using a generative model, based on the data representing the emergency scene, a descriptive summary of the emergency scene; and
providing the descriptive summary of the emergency scene to an emergency responder.

2. The computer-implemented method of claim 1, wherein the generative model comprises:
a classifier model configured to, based on the data representing the emergency scene, identify aspects of the emergency scene; and
a natural language processing model configured to, based on the aspects of the emergency scene, generate the descriptive summary of the emergency scene.

3. The computer-implemented method of claim 1, wherein the operations further comprise providing, using a conversational assistant, the descriptive summary of the emergency scene to the emergency responder.

4. The computer-implemented method of claim 1, wherein the operations further comprise:
detecting an emergency; and
automatically, in response to detecting the emergency:
capture the data representing the emergency scene;
generate the descriptive summary of the emergency; and
provide the descriptive summary to the emergency responder.

5. The computer-implemented method of claim 4, wherein detecting the emergency comprises receiving, from a person, an indication of the emergency.

6. The computer-implemented method of claim 4, wherein detecting the emergency comprises receiving, from a vehicle involved in the emergency, an indication of the emergency.

7. The computer-implemented method of claim 1, wherein the descriptive summary comprises at least some of the data representing the emergency scene.

8. The computer-implemented method of claim 1, wherein the descriptive summary is generated to assist the emergency responder in preparing for the emergency scene upon arrival.

9. The computer-implemented method of claim 1, wherein the descriptive summary comprises at least one of:
states of one or more vehicles involved in an accident at the emergency scene;
states of one or more airbags;
locations of one or more vehicles at the emergency scene;
a health status of one or more persons involved in the accident at the emergency scene;
locations of one or more persons involved in the accident;
a presence of fire;
a presence of water;
a presence of a roadway;
damage to a roadway;
a terrain topology;
a presence of a leaking fluid;
debris on a roadway;
a roadblock condition;
sounds at the emergency scene comprising speaking, crying, moaning, or barking;
a description of surroundings; or
a presence of weapons.

10. The computer-implemented method of claim 1, wherein:
the descriptive summary comprises text;
the operations further comprise providing the text to a text-to-speech (TTS) system, the TTS system configured to convert the text into TTS audio data that conveys the descriptive summary as synthetic speech; and
providing the descriptive summary of the emergency scene to the emergency responder comprises providing the TTS audio data to the emergency responder.

11. The computer-implemented method of claim 1, wherein capturing the data representing the emergency scene comprises capturing data using at least one of a camera or a microphone in communication with a user device associated with a person who is present at the emergency scene.

12. The computer-implemented method of claim 11, wherein the descriptive summary comprises an image of the person to facilitate identification of the person by the emergency responder.

13. The computer-implemented method of claim 1, wherein capturing the data representing the emergency scene comprises capturing data using at least one of a camera or a microphone of a vehicle involved in the emergency scene.

14. The computer-implemented method of claim 1, wherein capturing the data representing the emergency scene further comprises capturing sensor data from one or more sensors in communication with the data processing hardware, the one or more sensors comprising at least one of a speed sensor, an altitude sensor, an accelerometer, a braking sensor, a position sensor, a temperature sensor, or a light sensor.

15. A system comprising:
data processing hardware; and
memory hardware in communication with the data processing hardware, the memory hardware storing instructions that when executed on the data processing hardware cause the data processing hardware to perform operations comprising:
capturing data representing an emergency scene, the data comprising at least one of image data, sound data, or video data representing the emergency scene;
generating, using a generative model, based on the data representing the emergency scene, a descriptive summary of the emergency scene; and
providing the descriptive summary of the emergency scene to an emergency responder.

16. The system of claim 15, wherein the generative model comprises:
a classifier model configured to, based on the data representing the emergency scene, identify aspects of the emergency scene; and
a natural language processing model configured to, based on the aspects of the emergency scene, generate the descriptive summary of the emergency scene.

17. The system of claim 15, wherein the operations further comprise providing, using a conversational assistant, the descriptive summary of the emergency scene to the emergency responder.

18. The system of claim 15, wherein the operations further comprise:
detecting an emergency; and
automatically, in response to detecting the emergency:
capture the data representing the emergency scene;
generate the descriptive summary of the emergency; and
provide the descriptive summary to the emergency responder.

19. The system of claim 18, wherein detecting the emergency comprises receiving, from a person, an indication of the emergency.

20. The system of claim 18, wherein detecting the emergency comprises receiving, from a vehicle involved in the emergency, an indication of the emergency.

21. The system of claim 15, wherein the descriptive summary comprises at least some of the data representing the emergency scene.

22. The system of claim 15, wherein the descriptive summary is generated to assist the emergency responder in preparing for the emergency scene upon arrival.

23. The system of claim 15, wherein the descriptive summary comprises at least one of:
states of one or more vehicles involved in an accident at the emergency scene;
states of one or more airbags;
locations of one or more vehicles at the emergency scene;
a health status of one or more persons involved in the accident at the emergency scene;
locations of one or more persons involved in the accident;
a presence of fire;
a presence of water;
a presence of a roadway;
damage to a roadway;
a terrain topology;
a presence of a leaking fluid;
debris on a roadway;
a roadblock condition;
sounds at the emergency scene comprising speaking, crying, moaning, or barking;
a description of surroundings; or
a presence of weapons.

24. The system of claim 15, wherein:
the descriptive summary comprises text;
the operations further comprise providing the text to a text-to-speech (TTS) system, the TTS system configured to convert the text into TTS audio data that conveys the descriptive summary as synthetic speech; and
providing the descriptive summary of the emergency scene to the emergency responder comprises providing the TTS audio data to the emergency responder.

25. The system of claim 15, wherein capturing the data representing the emergency scene comprises capturing data using at least one of a camera or a microphone in communication with a user device associated with a person who is present at the emergency scene.

26. The system of claim 25, wherein the descriptive summary comprises an image of the person to facilitate identification of the person by the emergency responder.

27. The system of claim 15, wherein capturing the data representing the emergency scene comprises capturing data using at least one of a camera or a microphone of a vehicle involved in the emergency scene.

28. The system of claim 15, wherein capturing the data representing the emergency scene further comprises capturing sensor data from one or more sensors in communication with the data processing hardware, the one or more sensors comprising at least one of a speed sensor, an altitude sensor, an accelerometer, a braking sensor, a position sensor, a temperature sensor, or a light sensor.
